(19) United States
(12) Patent Application Publication
(10) Pub. No.: US 2024/0320525 A1
(43) Pub. Date: Sep. 26, 2024

(54) AI MODEL INFERENCE METHOD AND APPARATUS

(71) Applicant: FOUNDATION OF SOONGSIL UNIVERSITY-INDUSTRY COOPERATION, Seoul (KR)

(72) Inventors: Dae Seon CHOI, Daejeon (KR); Yoon Soo AN, Seoul (KR)

(21) Appl. No.: 18/678,657

(22) Filed: May 30, 2024

Related U.S. Application Data
(63) Continuation of application No. PCT/KR2023/006191, filed on May 8, 2023.

(30) Foreign Application Priority Data
Jul. 7, 2022 (KR) 10-2022-0083445

(51) Int. Cl. G06N 5/04

(52) U.S. Cl. CPC G06N 5/04

(57) ABSTRACT

disclosure An AI model inference apparatus includes: a processor; and a memory connected to the processor, wherein the memory stores program instructions executed by the processor to use an output value of a target model to determine whether the target model corresponds to any of a graybox environment or a blackbox environment, input the same data as the target model to a plurality of AI models included in a candidate model group to acquire the output value, process output values of each of the plurality of AI models differently according to the environment of the target model to acquire a first feature or a second feature, and input the output values of each of the plurality of AI models and the first feature or the second feature to a pre-trained model type classifier to determine the AI model corresponding to the target model.

### CROSS-REFERENCE TO RELATED APPLICATION

This application is a continuation of pending PCT International Application No. PCT/KR2023/006191, which was filed on May 8, 2023, and which claims priority to Korean Patent Application No. 10-2022-0083445 which was filed in the Korean Intellectual Property Office on Jul. 7, 2022. The disclosures of which are hereby incorporated by reference in their entireties.

### TECHNICAL FIELD

The present disclosure relates to an AI model inference method and apparatus.

### BACKGROUND ART

Artificial Intelligence is not only being introduced as a service in the fields of computer vision and natural language processing, but is also expanding into military fields and aircraft systems that require nationally important decisions. Commercialized AI models are distributed to users in a blackbox state that does not expose model information to protect intellectual property rights and information.

However, even in the blackbox state, the distributed AI models face the risk of training data information being leaked by attackers, or being attacked by degrading model performance or inducing the model to operate incorrectly.

A typical attack that extracts target model information in a blackbox environment is a model extraction attack in which an attacker queries a model and creates an alternative model similar to a target model.

Once a type of deep learning-based AI model may be inferred, since it is possible to easily create an alternative model having a structure more similar to the target model than to create an alternative model that imitates the function of the target model through the model extraction attack, it becomes easier to find parameters of model, ultimately making it possible to easily create a model in a blackbox environment into a model in a white box environment.

This makes it vulnerable to model inversion attacks, attacks that require alternative models including adversarial examples, and various other attacks. Therefore, from an attacker's perspective, being able to infer the type of model and know the layer composition information may be an important hint for attacking the target model.

### STATEMENT REGARDING PRIOR DISCLOSURES BY THE INVENTOR OR A JOINT INVENTOR

At least one inventor or joint inventor of the present disclosure has made related disclosures in Conference on Information Security and Cryptography Summer 2022-on Jun. 16, 2022.

### DISCLOSURE

### Technical Problem

In order to solve the problems of the related art described above, the present disclosure provides an AI model inference method and apparatus that, when commercializing an AI model, allows a model distributor to distribute the AI model with only limited information or induce to make inference of the AI model difficult through ensemble learning of multiple models.

### Technical Solution

To achieve the above object, according to an embodiment of the present disclosure, an AI model inference apparatus includes: a processor; and a memory connected to the processor, wherein the memory stores program instructions executed by the processor to use an output value of a target model to determine whether the target model corresponds to any of a graybox environment or a blackbox environment, input the same data as the target model to a plurality of AI models included in a candidate model group to acquire the output value, process output values of each of the plurality of AI models differently according to the environment of the target model to acquire a first feature or a second feature, and input the output values of each of the plurality of AI models and the first feature or the second feature to a pre-trained model type classifier to determine the AI model corresponding to the target model.

The plurality of AI models may include one of AlexNet, ResNet, VGGNet, and Simple ConvNet.

The program instructions may determine the environment of the target model as the graybox environment when the output value of the target model is a class-specific probability value and a class-specific probability ranking for the data input to the target model.

When it is determined that the environment of the target model is the graybox environment, the program instructions may obtain an average value of probability values of the remaining classes excluding a probability value of a correct answer class using the class-specific probability value output by each of the plurality of AI models, and 0 may be assigned to a class having a probability value smaller than the average value, 1 may be assigned to a class having a probability value greater than the average value, and the class-specific probability value output by each of the plurality of AI models may be processed into a first feature.

The program instructions may determine the environment of the target model as the blackbox environment when the output value of the target model is a class-specific probability ranking for the data input to the target model.

When the program instructions determine that the environment of the target model is the blackbox environment, the program instructions may determine an intermediate class depending on the class-specific probability ranking output by each of the plurality of AI models, and in a highest class, 1 may be assigned to the intermediate class and 0 may be assigned to a lowest class from a class next to the intermediate class to process the class-specific probability ranking output by each of the plurality of AI models into a second feature.

The model type classifier may be trained using the output values of each of the plurality of AI models and the first feature or the second feature in each of the graybox environment and the blackbox environment.

According to another embodiment of the present disclosure, an AI model inference method in an apparatus including a processor and memory includes: using an output value of a target model to determine whether the target model corresponds to any of a graybox environment or a blackbox environment; inputting the same data as the target model to a plurality of AI models included in a candidate model group to acquire the output value; processing output values of each of the plurality of AI models differently according to the environment of the target model to acquire a first feature or a second feature; and inputting the output values of each of the plurality of AI models and the first feature or the second feature to a pre-trained model type classifier to determine the AI model corresponding to the target model.

According to still another embodiment of the present disclosure, there is provided a computer-readable storage medium storing a program performing the method.

### Advantageous Effects

According to the present disclosure, by determining whether a target model is a graybox environment or a blackbox environment, processing an output value in different ways depending on the determined environment, and accurately inferring a model close to the target model using the processed information together, it is possible to induce a model distributor to strengthen the security of an AI model.

### BRIEF DESCRIPTION OF DRAWINGS

FIG. 1 is a diagram showing a configuration of an AI model inference apparatus according to a preferred embodiment of the present disclosure.

FIG. 2 is a diagram illustrating an AI model inference process in a graybox environment according to the present embodiment.

FIG. 3 is a diagram illustrating the AI model inference process in a blackbox environment.

FIG. 4 is a diagram describing a feature processing process according to the present embodiment.

FIG. 5 is a diagram illustrating performance when a model type classifier is trained using data to which a first feature is added based on an AUC and precision-recall graph in a graybox environment.

FIG. 6 is a diagram illustrating performance when a model type classifier is trained using data to which a second feature is added based on an AUC and precision-recall graph in a blackbox environment.

### BEST MODE

The present disclosure may be variously modified and have several exemplary embodiments. Therefore, specific exemplary embodiments of the present disclosure will be illustrated in the accompanying drawings and be described in detail. However, it is to be understood that the present disclosure is not limited to a specific embodiment, but includes all modifications, equivalents, and substitutions included in the spirit and technical scope of the present disclosure.

The terms used in the present specification are used only in order to describe specific exemplary embodiments rather than limiting the present disclosure. Singular forms are intended to include plural forms unless the context clearly indicates otherwise. It should be further understood that the term “include” or “have” used in the present specification is to specify the presence of features, numerals, steps, operations, components, parts mentioned in the present specification, or combinations thereof, but does not preclude the presence or addition of one or more other features, numerals, steps, operations, components, parts, or combinations thereof.

In addition, components of the embodiments described with reference to each drawing are not limitedly applied only to the corresponding embodiment, and may be implemented to be included in other embodiments within the scope of maintaining the technical spirit of the present disclosure. In addition, it goes without saying that these components may also be re-implemented as one embodiment in which a plurality of embodiments are integrated, even if a separate description is omitted.

In addition, in the description with reference to the accompanying drawings, regardless of reference numerals, the same components will be given the same or related reference numerals and duplicate description thereof will be omitted. When it is decided that the detailed description of the known art related to the present disclosure may unnecessarily obscure the gist of the present disclosure, a detailed description therefor will be omitted.

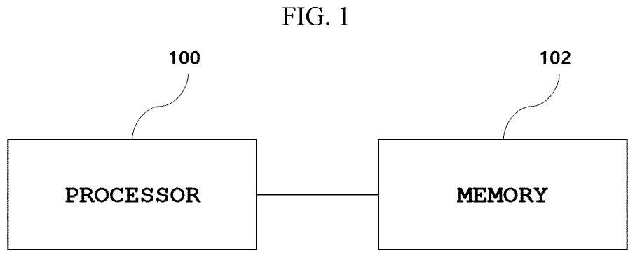

FIG. 1 is a diagram showing a configuration of an AI model inference apparatus according to a preferred embodiment of the present disclosure.

As shown in FIG. 1, the apparatus according to the present embodiment may include a processor 100 and a memory 102.

The processor 100 may include a central processing unit (CPU) capable of executing a computer program, other virtual machines, or the like.

The memory 102 may include a non-volatile storage device such as a non-removable hard drive or a removable storage device. The removable storage device may include a compact flash unit, a USB memory stick, and the like. The memory 102 may also include a volatile memory, such as various random access memories.

The memory 102 stores program instructions for inferring an AI model close to a target model.

According to the present embodiment, the program instructions use an output value of a target model to determine whether the target model corresponds to any of a graybox environment or a blackbox environment, input the same data as the target model to a plurality of AI models included in a candidate model group to acquire the output value, process output values of each of the plurality of AI models differently according to the environment of the target model to acquire a first feature or a second feature, and input the output values of each of the plurality of AI models and the first feature or the second feature to a pre-trained model type classifier to determine the AI model corresponding to the target model.

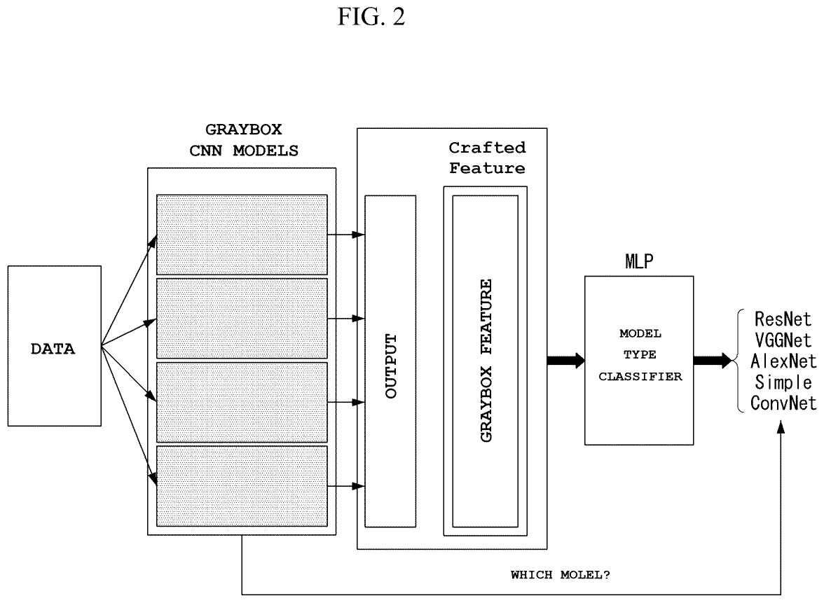

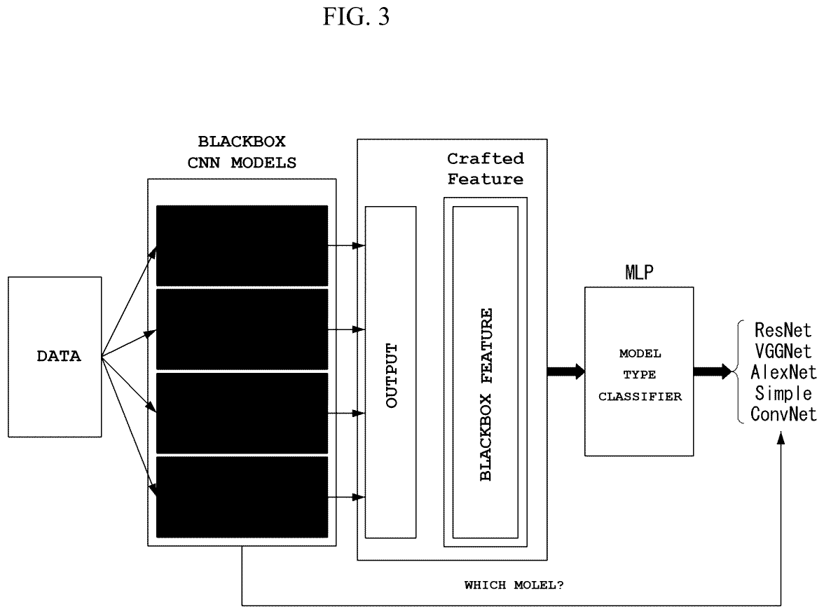

FIG. 2 is a diagram illustrating an AI model inference process in the graybox environment according to the present embodiment, and FIG. 3 is a diagram illustrating the AI model inference process in the blackbox environment.

In the present embodiment, the type of the target model is inferred by the output value that an attacker may obtain in the graybox environment and the blackbox environment.

In the apparatus according to the present embodiment, after the target model is distributed, when an attacker may approach the target model, in the case where the output value for the data input to the target model that the attacker may possess is a class-specific probability value and a class-specific probability ranking, the environment of the target model is determined to be the graybox environment, and when only the class-specific probability ranking information may be obtained, the environment of the target model is determined to be the blackbox environment.

According to the present embodiment, the output values of each of the plurality of AI models are input to a pre-trained model type classifier based on a multi-layer perceptron (MLP) to determine the AI model corresponding to the target model.

The model type classifier according to the present embodiment is composed of an input layer, an output layer, and two fully connected layers, and an activation function of a hidden layer may be ReLU, and an activation function of an output layer may be an MLP model using Softmax.

The AI model corresponding to the target model may be determined as one of the plurality of AI modules belonging to a candidate model group, and the plurality of AI models may include one of AlexNet, ResNet, VGGNet, and Simple ConvNet.

The AlexNet is a model having a structure of 5 convolutional layers and 3 fully-connected layers. The ReLu function is applied as the activation function. In addition, it is characterized by improving accuracy using overlapping pooling and local response normalization (hereinafter referred to as LRN).

The VGGNet has A, A-LRN, B, C, D, and E depending on a model depth. Among those, VGG16(D) and VGG19(E) are widely used in image recognition. It is a network studied with a focus on the effect of the model depth on an error rate of object recognition. Since the deeper the model depth, the better the performance, the VGGNet uses the smallest 3×3 convolution filter in all layers to apply as many ReLU activation functions as possible. As a result, the VGGNet may have stronger non-linearity and thus exhibit excellent performance, and CNN models after the VGGNet have a deeper structure than before.

The ResNet is a network which makes a small differential value converge to 0 as a neural network model deepens through skip connection (shortcut) and residual learning or solves gradient vanishing and gradient explosion problems where a large differential value diverges into an excessively large value, and enables high performance in sufficiently deep structures.

The Simple ConvNet is a simple structured convolutional network having two convolutional layers, two maxpooling, and a dropout layer (0.5).

According to the present embodiment, the model type classifier uses processed features that make data more intuitive and less noisy in order to more improve accuracy compared to when only an output value output by each AI model belonging to a candidate model group is used.

As described above, the apparatus according to the present embodiment uses the output value of the target model to determine whether the target model corresponds to any of the graybox environment or the blackbox environment, and inputs the same data as the target model to the plurality of AI models included in the candidate model group to acquire the output value.

Thereafter, the output values of each of the plurality of AI models are processed differently according to the environment of the target model to acquire the first feature or the second feature.

Finally, data in which the output value of the model and the features processed using the output value are combined are input to the model type classifier to infer the type of the AI model.

Hereinafter, the feature processing process will be described in more detail.

As described above, when the output value of the target model is the class-specific probability value and the class-specific probability ranking for the data input to the target model, the environment of the target model is defined as the graybox environment.

When the class-specific probability value (probability vector), which is information that may be obtained in the graybox environment, is a vector output from a model having high accuracy, since there is a large probability value only in the correct answer class due to the influence of the softmax function and the absolute value of the remaining probability values in the remaining classes becomes very small, the characteristics is suppressed from being intuitively revealed and the amount of information that may be transferred becomes scarce.

In the present embodiment, the output value in the graybox environment that reveals the relative size relationship between elements is processed into the first feature (feature 1) by correcting the influence of the softmax function.

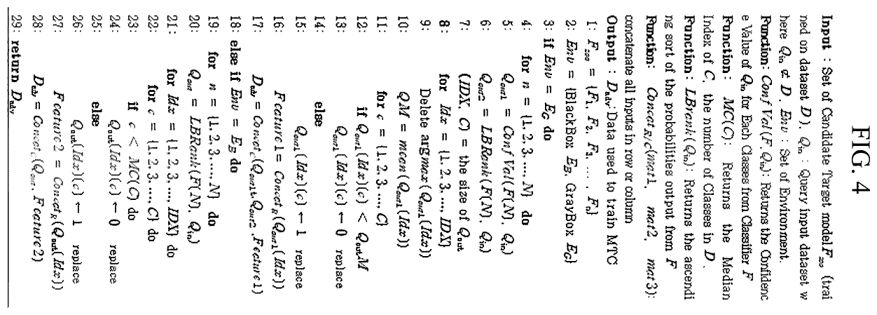

FIG. 4 is a diagram describing a feature processing process according to the present embodiment.

The process of processing the output value of the AI model into the first feature is the same as rows 7 to 14 of FIG. 4.

Referring to FIG. 4, an average value of the probability values of the remaining classes, excluding the probability value of the correct answer class, is calculated (rows 9 to 10), and 0 is assigned to a class with a value less than the average value and 1 is assigned to a class with a value greater than the average value to process the output value (class-specific probability value) output by the plurality of AI models belonging to the candidate model group into the first feature.

In the graybox environment, as illustrated in row 15 of FIG. 4, the class-specific probability values of each AI model, an ascending ranking (probability ranking) of class-specific probability, data in which the class-specific probability value of each AI model is combined with the first feature is input to the model type classifier to determine the AI model corresponding to the target model.

The model type classifier according to the present embodiment may be pre-trained using the class-specific probability value, the class-specific probability ranking, and the first feature, and may perform a process of determining the AI model corresponding to the target model after the training is completed.

The device according to the present embodiment defines the environment in which only the ranking information of the class-specific probability of the target model may be obtained as the blackbox environment.

In the blackbox environment where only the class-specific probability ranking information may be obtained, since the class-specific probability value is not known, according to the present embodiment, the intermediate class is determined according to the class-specific probability ranking, 1 is assigned to the intermediate class from the highest class, and 0 is assigned to the lowest class from the next class, so the class-specific probability ranking output by each AI model is processed into the second feature.

The method of processing the class-specific probability ranking into the second feature is the same as rows 20 to 26 of FIG. 4.

In the blackbox environment, the second feature processed as described above is used as the training data along with the class-specific ranking information output by each AI model belonging to the candidate model group to train the model type classifier and determine the AI model corresponding to the target model.

The model type classifier is trained using the output values from each of the graybox environment and the blackbox environment and the processed first or second features, and after the training is completed, infers the AI model that is closest to the target model among the plurality of AI models belonging to the candidate model group.

Hereinafter, the candidate model group for the target model is AlexNet, ResNet, VGGNet, and Simple ConvNet, which are CNN models, and an experiment on a process of AI model inference using 30,000 pieces of handwriting photos from the MNIST dataset is described.

Out of the MNIST training data, 30,000 pieces of data that are not used to train the target model are input to the target model, and the output probability vector obtained is used as the training data for the model type classifier. The model type classifier is trained with a total of 120,000 output probability vectors, 30,000 for each model.

Four model correct answer labels are used as the correct answer. When training the model type classifier, a learning rate is set to 0.001, an optimizer is set to RMSprop, a batch size is set to 256, and an epoch is set to 100, and the performance of MTC is compared by experimental condition through the test accuracy and training accuracy. All experiments used the same model with the same parameters fixed.

Through the model type classifier trained using the class-specific probability value and the class-specific probability ranking information of each AI model, as shown in Table 1 below, one of the AlexNet, ResNet, VGGNet, and Simple ConvNet models is classified as corresponding to the target model with a classification accuracy of 95% or more.

TABLE 1

| Model Type | accuracy |
|---|---|
| AlexNet | 0.99690 |
| ResNet | 0.96277 |
| VGGNet | 0.96990 |
| simple ConvNet | 0.95020 |

Table 2 below illustrates the model type classification results in each of graybox environment and blackbox environment.

TABLE 2

| | | MTC Performance | | | |
|---|---|---|---|---|---|
| | | GrayBox Attack | | BlackBox Attack | |
| | | GrayBox | Output + | BlackBox | Output + |
| Metric | Data | output | Feature1 | Output | Feature2 |

| | | | | |
|---|---|---|---|---|
| accuracy | 0.8072 | 0.8839 | 0.6693 | 0.8279 |
| ROC_AUC | 0.9488 | 0.9799 | 0.8720 | 0.9584 |

Referring to Table 2, the accuracy of the model type classifier trained only with the class-specific probability value of each AI model in the graybox environment (GrayBox Attack column in Table 2) is about 0.8, but the accuracy of the model type classifier trained using the first feature along with the class-specific probability value is about 0.88, and it can be seen that the type of model is inferred more efficiently by using the processed first feature.

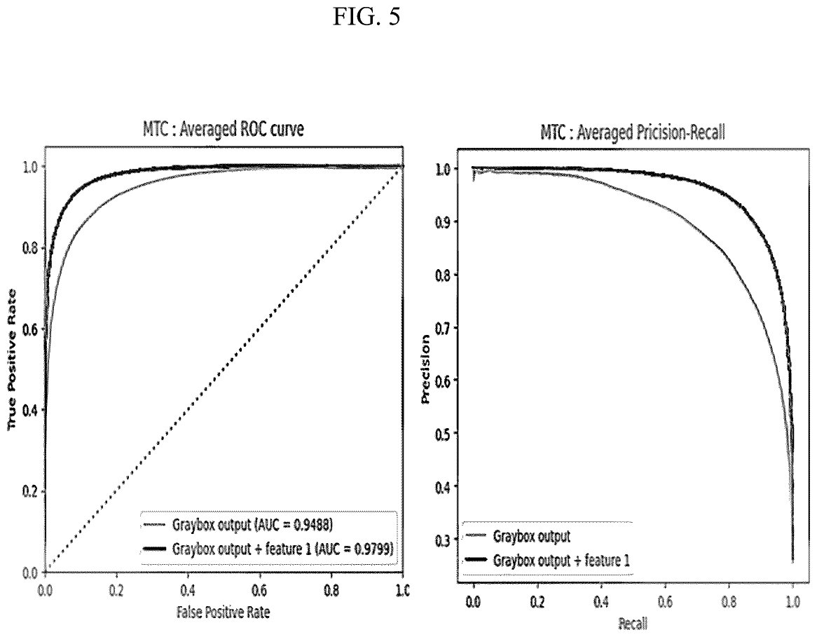

In addition, as illustrated in FIG. 5, when training the model type classifier using the data to which the first feature is added based on the AUC and precision-recall graph, it can be seen that the model classification performance is improved.

In the blackbox environment where an attacker may only know the class-specific probability ranking information output from the target model, when the model type classifier may accurately infer the model type, it may be a very serious vulnerability. In reality, there is a high possibility that the attacker will be provided with the model he or she wants to attack in the blackbox environment. The model type classification results in the blackbox environment are the same as the blackbox attack column in Table 2 above.

The accuracy of the model type classifier trained only on the class-specific ranking information of the model is about 0.66, and the performance of the model type inference is slightly lower since relatively limited information is provided compared to the graybox environment.

However, as in the present embodiment, when adding the second feature, it may be seen that the accuracy of the model type classifier is greatly improved to about 0.83.

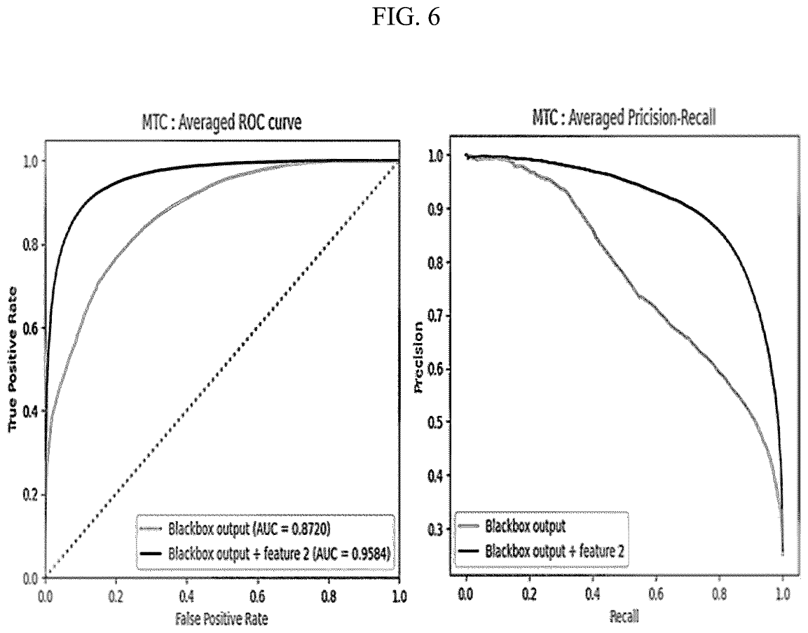

The effectiveness of the feature processing may also be confirmed on the ROC curve and precision-recall graph in FIG. 6.

There is a possibility that the attacker may infer the type of model even in the blackbox environment through the output value of the model and the simple feature processing, even without the class-specific probability value of the model.

According to the present embodiment, the graybox environment and the blackbox environment may be determined according to the information that may be obtained from the target model, the model type classifier may be trained using the features processed in each environment, and the type of target model may be determined to allow the model distributor to confirm in advance the security level of the model he/she distribute, thereby inducing to strengthen the security.

The embodiments of the present disclosure described above have been disclosed for illustrative purposes, and those skilled in the art with ordinary knowledge of the present disclosure will be able to make various modifications, changes, and additions within the spirit and scope of the present disclosure, and these modifications, changes, and additions should be regarded as falling within the scope of the following claims.

What is claimed is:

1. An artificial intelligence (AI) model inference apparatus, comprising:
a processor; and
a memory connected to the processor,
wherein the memory stores program instructions executed by the processor to use an output value of a target model to determine whether the target model corresponds to any of a graybox environment or a blackbox environment,
input the same data as the target model to a plurality of AI models included in a candidate model group to acquire the output value,
process output values of each of the plurality of AI models differently according to the environment of the target model to acquire a first feature or a second feature, and
input the output values of each of the plurality of AI models and the first feature or the second feature to a pre-trained model type classifier to determine the AI model corresponding to the target model.

2. The AI model inference apparatus of claim 1, wherein the plurality of AI models include one of AlexNet, ResNet, VGGNet, and Simple ConvNet.

3. The AI model inference apparatus of claim 1, wherein the program instructions determine the environment of the target model as the graybox environment when the output value of the target model is a class-specific probability value and a class-specific probability ranking for the data input to the target model.

4. The AI model inference apparatus of claim 3, wherein when it is determined that the environment of the target model is the graybox environment, the program instructions obtain an average value of probability values of the remaining classes excluding a probability value of a correct answer class using the class-specific probability value output by each of the plurality of AI models, and
0 is assigned to a class having a probability value smaller than the average value, 1 is assigned to a class having a probability value greater than the average value, and the class-specific probability value output by each of the plurality of AI models is processed into a first feature.

5. The AI model inference apparatus of claim 1, wherein the program instructions determine the environment of the target model as the blackbox environment when the output value of the target model is a class-specific probability ranking for the data input to the target model.

6. The AI model inference apparatus of claim 5, wherein when the program instructions determine that the environment of the target model is the blackbox environment, the program instructions determine an intermediate class depending on the class-specific probability ranking output by each of the plurality of AI models, and
in a highest class, 1 is assigned to the intermediate class and 0 is assigned to a lowest class from a class next to the intermediate class to process the class-specific probability ranking output by each of the plurality of AI models into a second feature.

7. The AI model inference apparatus of claim 1, wherein the model type classifier is trained using the output values of each of the plurality of AI models and the first feature or the second feature in each of the graybox environment and the blackbox environment.

8. An artificial intelligence (AI) model inference method in an apparatus including a processor and memory, comprising:
using an output value of a target model to determine whether the target model corresponds to any of a graybox environment or a blackbox environment;
inputting the same data as the target model to a plurality of AI models included in a candidate model group to acquire the output value;
processing output values of each of the plurality of AI models differently according to the environment of the target model to acquire a first feature or a second feature; and
inputting the output values of each of the plurality of AI models and the first feature or the second feature to a pre-trained model type classifier to determine the AI model corresponding to the target model.

9. The AI model inference method of claim 8, wherein in the determining, the environment of the target model is determined as the graybox environment or the blackbox environment depending on whether the output value of the target model includes both a class-specific probability value and a class-specific probability ranking for the data input to the target model and whether the environment of the target model includes only the class-specific probability ranking.

10. A non-transitory computer-readable storage medium storing a program for performing the method according to claim 8.
